(19) United States
(12) Patent Application Publication
(10) Pub. No.: US 2007/0041366 A1
(43) Pub. Date: Feb. 22, 2007

(54) Distributed conference bridge

(75) Inventors: Yan Vugenfirer, Netanya (IL); Ronen Bartal, Emek Hefer (IL)

Correspondence Address: LADAS & PARRY, 26 WEST 61ST STREET, NEW YORK, NY, 10023, US

(73) Assignee: SMART LINK LTD.

(21) Appl. No.: 11/438,478

(22) Filed: May 22, 2006

Related U.S. Application Data
(60) Provisional application No. 60/683,766, filed on May 24, 2005.

(51) Int. Cl. H04L 12/66; H04M 3/42

(52) U.S. Cl. 370/352; 379/202.01

(57) ABSTRACT

A method for communication includes specifying a group of packet telephony terminals that are to participate in a telephone conference. Based on the list, a conference topology is defined in which at least two of the terminals serve as bridge nodes, which are associated respectively with mutually-disjoint sets of the terminals. Telephony connections are set up over a packet network between first and second bridge nodes, and between the first bridge node and each of the terminals in a first set of the terminals, and between the second bridge node and each of the terminals in a second set. Audio signals conveyed over the telephony connections are mixed at each of the bridge nodes so as to join the first and second sets of the terminals together with the first and second bridge nodes in the telephone conference.

### CROSS-REFERENCE TO RELATED APPLICATION

This application claims the benefit of U.S. Provisional Patent Application 60/683,766, filed May 24, 2005, which is incorporated herein by reference.

### FIELD OF THE INVENTION

The present invention relates generally to telephone conferencing, and specifically to systems, methods and software for telephone conference bridging over packet networks.

### BACKGROUND OF THE INVENTION

Telephone conferencing systems are commonly used in connecting multiple participants in a single telephone call. Typically, in such systems, the participants receive a call-in number and code for calling the conference bridge. One of the participants is designated the conference leader. All of the participants dial in to the bridge at the appointed time. The conference begins when the leader comes on line (and ends if and when the leader drops off the call). The bridge is responsible for mixing and distributing the audio signals from all of the participants into a single, stream, which it then distributes to all the participants.

Jajah (www.jajah.com) offers another sort of Web-based telephone service. A user connects to the Jajah server via the Internet and inputs the telephone numbers of the parties who are to participate in the call. The server then dials the numbers and, when the participants pick up, connects the participants through a Voice over Internet Protocol (VoIP) connection. Jajah announced and released this service after the filing date of the above-mentioned provisional patent application.

U.S. Pat. No. 6,754,323, whose disclosure is incorporated herein by reference, describes a method for automatically establishing a conference call. A user selects desired conference invitees from a call log of a communication device. A service node then connects the invitees to the call using the directory number associated with the call log. Invitee action is not required in order to connect to the conference bridge.

### SUMMARY OF THE INVENTION

In embodiments of the present invention, conference bridge functionality is distributed among multiple nodes in a packet communication network. In other words, call management and audio mixing are performed by two or more different computers in a single call. As a result, multiple peer computers may share the load of computation-intensive real-time audio mixing, thus permitting large-scale conferences to be conducted over the network without reliance on a powerful central server. This distributed conference bridge functionality is capable of joining participants using different packet telephony protocols in a single call. One or more of the nodes may also be used to conference in participants via the public switched telephone network (PSTN).

In some embodiments of the present invention, distributed conference management software on the peer computers tracks the topology and status of call connections of the conference participants. If one of the peer computers drops out of the call or a connection is otherwise lost, the remaining peer computers automatically rearrange the call topology in order to enable the remaining call participants to continue the conference.

There is therefore provided, in accordance with an embodiment of the present invention, a computer-implemented method for communication, including:

specifying a group of packet telephony terminals that are to participate in a telephone conference;

defining, based on the list, a conference topology in which at least two of the terminals serve as bridge nodes, including at least first and second bridge nodes, which are associated respectively with mutually-disjoint first and second sets of the terminals, each of the first and second sets including one or more of the terminals;

setting up telephony connections over a packet network between the first and second bridge nodes, and between the first bridge node and each of the terminals in the first set, and between the second bridge node and each of the terminals in the second set; and

mixing, at each of the bridge nodes, audio signals conveyed over the telephony connections so as to join the first and second sets of the terminals together with the first and second bridge nodes in the telephone conference.

In some embodiments, defining the conference topology includes defining a tree topology, in which the bridge nodes include a third bridge node, which is associated with a third set of the terminals, disjoint from the first and second sets, and setting up the telephony connections includes connecting the first and third bridge nodes and connecting the third bridge node to at least one terminal in the third set.

Typically, defining the conference topology includes assigning the terminals to the first and second sets so as to balance a computational load of mixing the audio signals between the bridge nodes. Additionally or alternatively, defining the conference topology includes assigning the terminals to the first and second sets responsively to a proximity between each of the bridge nodes and each of the terminals.

In a disclosed embodiment, setting up the telephony connections includes establishing at least a first connection between the first bridge node and a first terminal in accordance with a first telephony protocol, and establishing at least a second connection between the first bridge node and a second terminal in accordance with a second telephony protocol, different from the first telephony protocol, and mixing the audio signals includes exchanging the audio signals at the first bridge node between at least the first and second connections.

In some embodiments, the method includes placing a call over a public switched telephone network (PSTN) between one of the packet telephony terminals and an analog telephone, and mixing the audio signals includes joining the analog telephone in the telephone conference via the one of the packet telephony terminals.

Typically, specifying the group of packet telephony terminals includes receiving an input from a user of one of the terminals of a list of participants, and determining the terminals that are to be used respectively by the participants in the telephone conference by sending and receiving messages over the packet network. Additionally or alternatively, specifying the group of packet telephony terminals includes receiving an input from a user of one of the terminals indicating a time at which the telephone conference is to begin, and setting up the telephony connections includes creating the connections automatically at the indicated time without further input from the user.

In disclosed embodiments, defining the conference topology and setting up the telephony connections includes exchanging messages among the terminals so as to define the conference topology and set up the connections automatically, without intervention of a user. Exchanging the messages may include determining that at least one of the connections connecting at least one of the terminals to the conference has been broken, and exchanging the messages during the telephone conference so as to reconnect the at least one of the terminals to the telephone conference in accordance with a backup topology.

In an alternative embodiment, the method includes sending a multicast message over the telephony connections from a first terminal to all of the other terminals.

There is also provided, in accordance with an embodiment of the present invention, apparatus for operation as a packet telephony terminal, including:

a network communication interface, for communicating with other packet telephony terminals over a packet network; and

a processor, which is arranged to receive an input specifying a group of the terminals that are to participate in a telephone conference, the group including the apparatus and a plurality of the other packet telephony terminals, wherein the processor is operative to define, based on the list, a conference topology in which at least two of the terminals serve as bridge nodes, including at least first and second bridge nodes, which are associated respectively with mutually-disjoint first and second sets of the terminals, each of the first and second sets including one or more of the terminals,

wherein the processor is further arranged, in conjunction with the other terminals in the group, to cause telephony connections to be set up over the packet network between the first and second bridge nodes, and between the first bridge node and each of the terminals in the first set, and between the second bridge node and each of the terminals in the second set, and to mix audio signals conveyed over the telephony connections so as to join the first and second sets of the terminals together with the first and second bridge nodes in the telephone conference.

There is additionally provided, in accordance with an embodiment of the present invention, a system for communication, including a plurality of packet telephony terminals, which are interconnected via a packet network, wherein at least one of the terminals is arranged to receive an input specifying a group of the terminals that are to participate in a telephone conference, and to define, based on the list, a conference topology in which at least two of the terminals serve as bridge nodes, including at least first and second bridge nodes, which are associated respectively with mutually-disjoint first and second sets of the terminals, each of the first and second sets including one or more of the terminals,

wherein the terminals are arranged to set up telephony connections over the packet network between the first and second bridge nodes, and between the first bridge node and each of the terminals in the first set, and between the second bridge node and each of the terminals in the second set, and to mix at each of the bridge nodes audio signals conveyed over the telephony connections so as to join the first and second sets of the terminals together with the first and second bridge nodes in the telephone conference.

There is further provided, in accordance with an embodiment of the present invention, a computer software product for use on a computer that is configured to operate as packet telephony terminal in communication with other packet telephony terminals over a packet network, the product including a computer-readable medium in which program instructions are stored, which instructions, when read by the computer, cause the computer to receive an input specifying a group of the terminals that are to participate in a telephone conference, the group including the packet telephony terminal and a plurality of the other packet telephony terminals, wherein the instructions cause the computer to define, based on the list, a conference topology in which at least two of the terminals serve as bridge nodes, including at least first and second bridge nodes, which are associated respectively with mutually-disjoint first and second sets of the terminals, each of the first and second sets including one or more of the terminals,

wherein the instructions further cause the computer to operate in conjunction with the other terminals in the group so as to cause telephony connections to be set up over the packet network between the first and second bridge nodes, and between the first bridge node and each of the terminals in the first set, and between the second bridge node and each of the terminals in the second set, and cause the computer to mix audio signals conveyed over the telephony connections so as to join the first and second sets of the terminals together with the first and second bridge nodes in the telephone conference.

The present invention will be more fully understood from the following detailed description of the embodiments thereof, taken together with the drawings in which:

### BRIEF DESCRIPTION OF THE DRAWINGS

FIG. 1 is a schematic, pictorial illustration showing a system for telephone conferencing, in accordance with an embodiment of the present invention;

FIG. 2 is a block diagram showing a logical topology of a telephone conference, in accordance with an embodiment of the present invention;

FIG. 3 is a block diagram that schematically shows functional elements of a computer used in conducting a telephone conference, in accordance with an embodiment of the present invention; and

FIG. 4 is a flow chart that schematically illustrates a method for establishing and conducting a telephone conference, in accordance with an embodiment of the present invention.

### DETAILED DESCRIPTION OF EMBODIMENTS

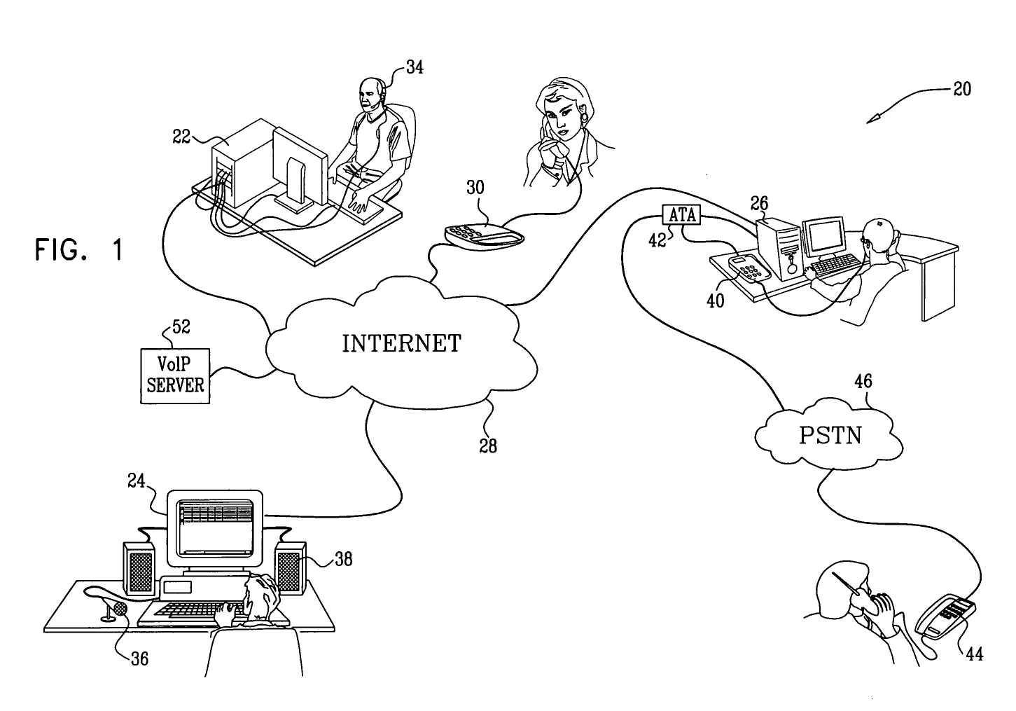

FIG. 1 is a schematic, pictorial illustration of a system 20 for telephone conferencing, in accordance with an embodiment of the present invention. Multiple packet telephony terminals, such as personal computers 22, 24, 26, etc., are connected to communicate via a packet network 28, such as the public Internet. The computers are configured with appropriate hardware and software for VoIP telephone conferencing, as described in detail hereinbelow. Typically, each computer comprises a processor, network interface, and audio input/output (I/O) devices, such as a headset 34 or a microphone 36 and speakers 38. Additionally or alternatively, the terminals used in embodiments of the present invention may comprise dedicated packet telephony devices, such as a VoIP phone 30 (which integrates the necessary hardware and software elements in a telephone-like package).

The packet telephony terminals in system 20 may communicate with one another using any suitable packet telephony protocols known in the art. For example, the terminals may use the Session Initiation Protocol (SIP) or H.323 for call signaling. As another example, the terminals may use proprietary protocols, such as Skype™. One or more VoIP servers 32 may be used in setting up the calls. In general, however, there is no central conference bridge responsible for setting up and coordinating the calls in the typical point-to-multipoint (star) conference topology. Rather, as described in detail hereinbelow, the conference call is set up as a web of point-to-point calls among the participating terminals. The individual point-to-point calls that are joined in the conference may be made either directly or via suitable VoIP servers, possibly using two or more different servers and/or different packet telephony protocols in the same conference. For example, assuming computer 22 is set up to place VoIP calls using both H.323 and Skype, this computer may communicate simultaneously with computer 26 using Skype and with VoIP phone 30 using H.323, while conferencing and mixing together the audio signals from the two calls internally.

Additionally or alternatively, the telephone conference may include parties who communicate with the other parties not directly by VoIP, but rather via a public switched telephone network (PSTN) 46 or via another communication network, such as a cellular network. For this purpose, one or more of the terminals involved in the conference may be configured to serve as a local gateway between packet network 28 and the PSTN. This sort of gateway function is described, for example, in U.S. patent application Ser. No. 11/326,507, filed Jan. 5, 2006, which is assigned to the assignee of the present patent application and whose disclosure is incorporated herein by reference. In the embodiment shown in FIG. 1, computer 26 connects to PSTN 46 using a suitable analog telephone adapter (ATA) 42, thus enabling an analog PSTN telephone 44 to communicate with the computer. Further additionally or alternatively, ATA 42 may be configured to connect directly to an analog telephone 40, so that the user of computer 26 may operate telephone 40 as an audio I/O device in VoIP calls. Computer 26 mixes the digital audio samples from the VoIP and PSTN calls as required, and outputs mixed sample streams via ATA 42 to PSTN 46, as well as in VoIP packets transmitted over network 28.

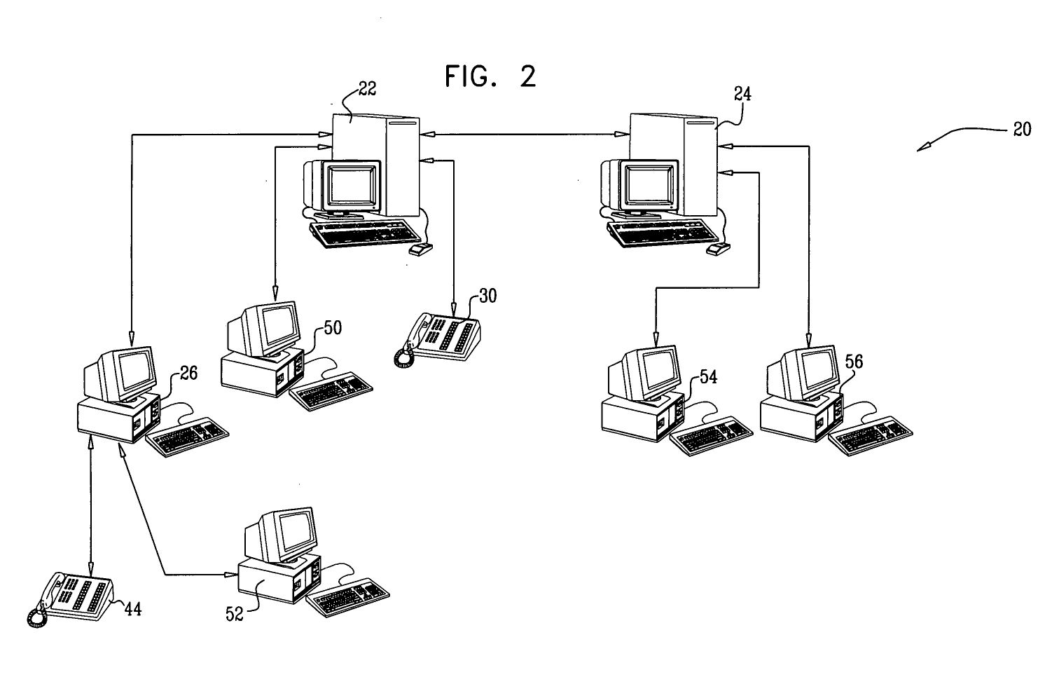

FIG. 2 is a block diagram that schematically illustrates the logical topology of a telephone conference that is set up using system 20, in accordance with an embodiment of the present invention. The topology has the general form of a tree of point-to-point connections made via packet network 28 and, in the case of telephone 44, via PSTN 46. Several nodes in the tree serve as bridge nodes (in this example, nodes 22, 24 and 26), with simultaneous telephone connections to two or more other nodes. Computer 22 can be seen as the root of the tree, with simultaneous connections to computers 24, 26 and 50 and to VoIP phone 30, all via network 28. Computer 24 connects to computer 54 and 56, while computer 26 connects to telephone 44 and to a computer 52. This exemplary topology, with nine nodes in total including three bridge nodes, is shown solely by way of example of a non-star topology (i.e., a topology that does not have a single point-to-multipoint form) that may be realized in an embodiment of the present invention. Other such topologies, which may include larger or smaller numbers of total nodes and bridge nodes, will be apparent to those skilled in the art and are considered to be within the scope of the present invention.

The topology of the telephone conference is set up by communication among the terminals that are to participate in the conference. The procedures and software components that participate in setting up and carrying out the conference are described in detail with reference to the figures that follow. The conference topology may be set up automatically by the terminals based on instructions from the user or users who initiate the conference. Each computer 22, 24 and 26 that serves as a bridge node is then responsible for mixing the audio signals that it receives over the network from each of the other terminals to which it is connected and as audio input from the computer user. The computer outputs the appropriate mixed audio signals to the computer user and to the other terminals to which it is connected. For example, computer 24 will mix the audio signals received from computers 22, computer 54 and microphone 36 (FIG. 1) for output to computer 56; while mixing the audio signals received from computer 54, computer 56 and microphone 36 for output to computer 22; and mixing the audio signals from all of computers 22, 54 and 56 for output to the user via speakers 38.

The number of terminals connected to each bridge node is determined, inter alia, based on the computing power of the node in order to ensure good audio quality. In this manner, it is possible to build very large conference topologies with good audio quality, without overburdening the resources of any of the bridge nodes.

The sort of topology shown in FIG. 2 may also be used for real-time peer-to-peer multicast applications. In this case, multicast content (which may comprise text and/or video, in addition to or instead of audio) is transmitted from the head of the tree down to all of the nodes via automatically-established VoIP connections.

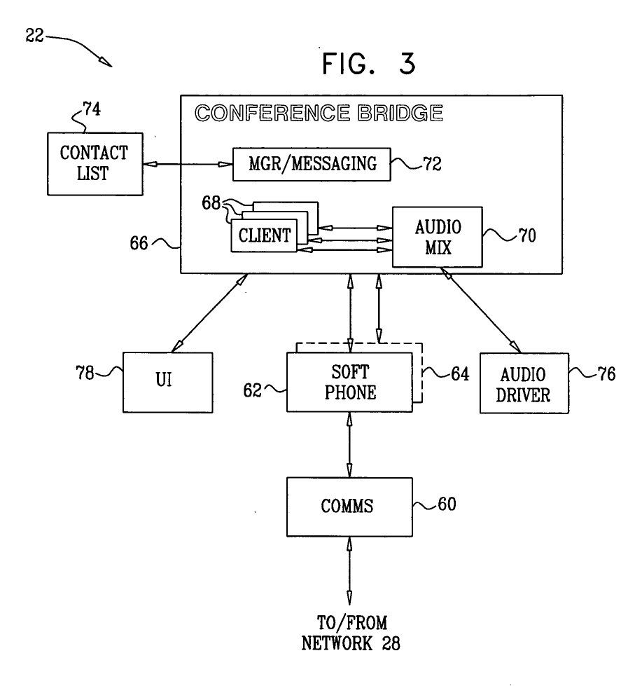

FIG. 3 is a block diagram that schematically shows details of the functional structure of computer 22, in accordance with an embodiment of the present invention. The other bridge nodes in system 20, such as computers 24 and 26, typically have a similar structure, which may also be shared by some or all of the leaf nodes in the conference topology. The functions shown in FIG. 3 are generally carried out by software running on the central processing unit (CPU) of the computer, although alternatively, some of these functions may be carried out by a digital signal processor (DSP) or by programmable or hard-wired logic. The software for carrying out these functions may be downloaded to the computer in electronic form, over a network, for example, or it may alternatively be provided on tangible media, such as optical, magnetic or electronic memory media. Only those elements that are useful for an understanding of this embodiment are included in FIG. 3, while other, generic elements, which will be apparent to those skilled in the art, are omitted here for the sake of simplicity.

Although it is assumed in this embodiment that the conference bridge capabilities and functions described herein reside on a general-purpose computer, these capabilities and functions may, alternatively or additionally, be embedded in equipment of other types with suitable computing capabilities, such as in VoIP phone 30 or ATA 42. References to “computer-implemented” methods in the present patent application and in the claims should thus be understood to comprise within their scope implementations of such methods on embedded computing devices in any suitable type of equipment.

A soft phone application 62 running on computer 22 communicates with other terminals in the telephone conference via a communications interface 60. As noted earlier, application 62 may comprise a standard SIP- or H.323-based telephony application or a proprietary application, such as Skype. Optionally, computer 22 may run one or more additional, different soft phone applications 64 simultaneously with application 62. In this case, application 62 may be used in communicating with computer 26, for example, while application 64 is used in communicating with computer 24 or VoIP phone 30. Communications interface 60 comprises suitable hardware and software for linking computer 22 to network 28, typically via a broadband modem or local area network (LAN) (not shown).

The telephone conferencing functions of computer 22 are implemented by a conference bridge application 66. This application spawns a conference client instance 68 for each of the point-to-point telephone connections that computer 22 makes during the conference. In other words, in the example shown in FIG. 2, the conference bridge application on computer 22 will run four client instances, one for each of computers 24, 26, 50 and phone 30. Each conference client instance interacts with the appropriate soft phone application 62, 64 for the corresponding connection in order to send and receiving VoIP signaling and media packets over that connection.

The conference bridge application creates a virtual audio device to be used with each of client instances 68. Each client instance is set to work with its respective virtual audio device. (Alternatively, one multi-streaming audio device may be used to provide dedicated input and output streams to each soft phone application.) Mixer 70 receives audio input from the virtual audio devices and from the actual audio I/O device that is connected to computer 22 (such as headset 34 in the example shown in FIG. 1) via an appropriate audio driver 76. The mixer processes the audio data from the actual and virtual devices to generate mixed output data streams. The mixer transfers the appropriate mixed data streams to audio driver 76 for output to the computer user and to client instances 68 for packetization and transmission by the appropriate soft phone application 62, 64.

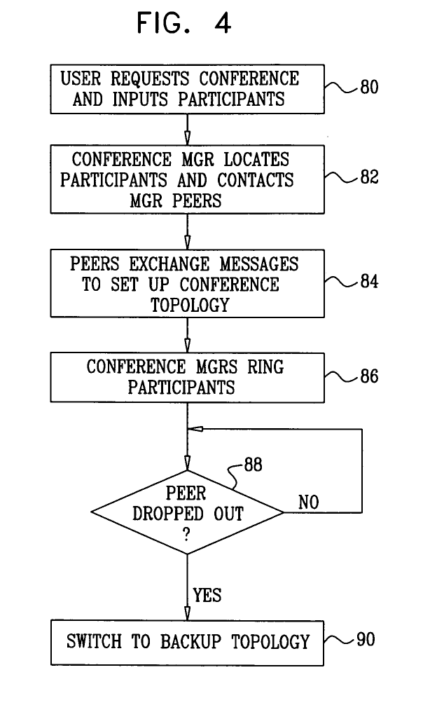

The functions of conference bridge application 66 are controlled by a software routine referred to as a conference manager 72. The manager performs several functions:
Receiving inputs from the user of computer 22 via a user interface (UI) 78 (assuming that the user of computer 22 is the initiator and/or involved in setup of the call). The user inputs the conference call details, including the parties who are to participate in the call, the time the call is to take place, and other conference parameters. The user may input the details of the parties manually or, alternatively, the user may select the parties from a contact list 74. This contact list may comprise a VoIP contact list maintained by soft phone application 62 or 64, a conference contact list maintained by conference bridge application 66, a generic contact list (imported, for example, from Microsoft Outlook™ or Lotus Notes™), or a combination of lists from different sources.
Messaging over network 28 to and from other terminals participating in the conference, both during pre-conference setup and while the conference is running. Details of the messaging interaction among the conference terminals are described hereinbelow with reference to FIG. 4. Messaging among the terminals may use an existing network messaging interface, such as ICQ™ or MSN™ instant messaging, or may alternatively be based on a proprietary messaging protocol. This messaging is used, inter alia, in determining the conference topology and in modifying the topology during the conference if necessary in case a participant drops out or a connection is lost.
Generation and management of clients 68 in accordance with the conference topology, and controlling audio mixer 70 accordingly.

FIG. 4 is a flow chart that schematically illustrates a method for establishing and conducting a telephone conference in system 20, in accordance with an embodiment of the present invention. For the sake of clarity, the method of FIG. 4 is described hereinbelow with reference to the exemplary topology shown in FIGS. 1 and 2 and the software structure shown in FIG. 3. The principles of this method, however, may similarly be implemented in other topologies and using other software and hardware structures.

The method of FIG. 4 is initiated when a user, such as the user of computer 22, invokes conference bridge application 66, at a conference request step 80. The user identifies the conference participants and their VoIP contact information, either by selection from contact list 74 or by manual input. The contact information for each participant typically includes an identification of the soft phone application that can be used to reach the participant and the identifier associated with the participant in that application (such as the participant's VoIP telephone number or Skype user name). In some cases, one or more of the participants, such as the user of telephone 44, may be reachable only via PSTN 46, in which case the user of computer 22 indicates the telephone number at which the participant can be reached. The user also indicates the time at which the conference is to start, and may also input other parameters, such as the planned conference duration and topic, as well as shared resources to be used during the conference, such as a presentation or whiteboard application, for example.

Once the user has completed step 80, conference manager 72 proceeds to set up the conference automatically, at a conference initiation step 82. The conference manager locates the other conference participants (possibly by querying VoIP server 32), and then sends messages to the terminals of the other participants inviting them to participate in the conference. The messages are directed to the peer conference managers on other terminals that are running conference bridge application 66. The conference manager may use advance knowledge of the deployment of the conference bridge application on the other terminals in order to choose the terminals to which the messages should be sent at step 66, or it may alternatively query the other participants as to their conference bridge capabilities, using an instant messaging protocol, for example. Typically, the messages include the participant list and other conference details input by the user of computer 22. It is not necessary that all the participants' terminals run the conference bridge application, since those terminals that are not configured to operate as bridge nodes will simply be positioned as “leaves” in the conference topology. The leaf nodes will be contacted by other terminals that are configured to serve as bridge nodes in the topology. Thus, in the present example, it is assumed that the conference bridge application is necessarily running only on computers 22, 24 and 26 (though it may also be running on one or more of the leaf terminals).

The peer conference managers 72 on computers 24 and 26 exchange messages with the conference manager on computer 22 in order to set up the conference topology, at a conference setup step 84. At this step, the terminals that are to serve as bridge nodes are identified, the connections among the bridge nodes are defined, and the leaf terminals are assigned to the bridge nodes that are to serve them. Thus, the entire topology shown in FIG. 2 is laid out. Various factors may be taken into account in building the topology:
Balancing the load of audio mixing among the bridge nodes, in proportion to the computational capabilities of each of the computers that will perform the function.
Network connections, software and protocol capabilities of the terminals. For example, computer 26 is assigned to communicate with telephone 44, since computer 26 is known to have a suitable connection to PSTN 46 via ATA 42. As another example, computer 26 may be configured to communicate using Skype, while computer 24 is configured to communicate using H.323, and computer 22 is configured to support both protocols and thus provide the necessary interworking between them. (In an alternative embodiment, not shown in the figures, groups of computers running different VoIP protocols may be linked together through the PSTN, by means of a computer in each group that has a suitable PSTN interface.)
Communication bandwidth and geographical proximity of the terminals, which are factored into the topology computation in order to optimize audio quality and minimize latency.
Other preset policies and preferences.
   Standby connections may also be defined, for use as backup links in case any of the active links stops functioning during the conference.

Any suitable messaging protocol and computational method may be used in building the conference topology. For example, one of the conference managers—such as manager 72 running on computer 22, for instance—may serve as the conference organizer. The organizer collects the relevant information from the other managers, computes the topology that is to be used, and then sends instructions to the other managers accordingly. (Although computer 22 was also identified at step 80 as the terminal on which a user initiates the conference, the conference managers that serve respectively as conference initiator and conference organizer may run on different computers.) Alternatively, the conference managers may exchange information and negotiate the conference topology using a distributed protocol without a single manager. This latter approach may be more complex to implement than a centralized approach built around a single organizer, but it may also be more resistant to collapse of the conference if the computer serving as conference organizer fails, loses communications, or otherwise drops out of the conference. A standby organizer may alternatively be selected at step 84 for backup in such cases.

At the appointed time for the conference, conference manager 72 on each of the bridge nodes (computers 22, 24 and 26 in the present example) places a call to each of the terminals to which it has been assigned to connect, at a call placement step 86. The conference manager on each of the bridge nodes also signals the user of that node to indicate that the conference is about to start. Each conference manager spawns client instances 68 for all of the call connections in which it is participating, regardless of whether the conference manager itself has initiated the particular connection or whether the call connection was initiated by another bridge node. The conference manager activates audio mixer 70 to mix the audio signals received from and sent to the various client instances, and the conference proceeds.

During the conference, conference managers 72 of the participating terminals continue to exchange messages in order to track the call connections and ensure that all of the participating terminals remain connected, at a conference monitoring step 88. In this manner, if one of the bridge nodes drops out of the conference or a connection is otherwise lost for any reason, the remaining conference managers can quickly detect the missing node and switch to a backup topology, at a backup step 90. For example, if computer 24 drops out, computer 50 may be assigned to place calls to computers 54 and 56 and thus to serve as the bridge node for these computers in place of computer 24. (In situations requiring especially high reliability, computer 50 may place the calls to computers 54 and 56 at the beginning of the conference, and may keep the calls open without actually transmitting audio signals over these connections until a failure occurs, at which point the connections are activated.) The conference may thus continue with rearranged topology even if the conference organizer (computer 22 in the present example) drops out of the call.

The conference continues in this manner until all the participants have signed off, whereupon the calls are terminated and the conference ends.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for communication, comprising:
specifying a group of packet telephony terminals that are to participate in a telephone conference;
defining, based on the list, a conference topology in which at least two of the terminals serve as bridge nodes, comprising at least first and second bridge nodes, which are associated respectively with mutually-disjoint first and second sets of the terminals, each of the first and second sets comprising one or more of the terminals;
setting up telephony connections over a packet network between the first and second bridge nodes, and between the first bridge node and each of the terminals in the first set, and between the second bridge node and each of the terminals in the second set; and
mixing, at each of the bridge nodes, audio signals conveyed over the telephony connections so as to join the first and second sets of the terminals together with the first and second bridge nodes in the telephone conference.

2. The method according to claim 1, wherein defining the conference topology comprises defining a tree topology, in which the bridge nodes comprise a third bridge node, which is associated with a third set of the terminals, disjoint from the first and second sets, and
wherein setting up the telephony connections comprises connecting the first and third bridge nodes and connecting the third bridge node to at least one terminal in the third set.

3. The method according to claim 1, wherein defining the conference topology comprises assigning the terminals to the first and second sets so as to balance a computational load of mixing the audio signals between the bridge nodes.

4. The method according to claim 1, wherein defining the conference topology comprises assigning the terminals to the first and second sets responsively to a proximity between each of the bridge nodes and each of the terminals.

5. The method according to claim 1, wherein setting up the telephony connections comprises establishing at least a first connection between the first bridge node and a first terminal in accordance with a first telephony protocol, and establishing at least a second connection between the first bridge node and a second terminal in accordance with a second telephony protocol, different from the first telephony protocol, and
wherein mixing the audio signals comprises exchanging the audio signals at the first bridge node between at least the first and second connections.

6. The method according to claim 1, and comprising placing a call over a public switched telephone network (PSTN) between one of the packet telephony terminals and an analog telephone, and wherein mixing the audio signals comprises joining the analog telephone in the telephone conference via the one of the packet telephony terminals.

7. The method according to claim 1, wherein specifying the group of packet telephony terminals comprises receiving an input from a user of one of the terminals of a list of participants, and determining the terminals that are to be used respectively by the participants in the telephone conference by sending and receiving messages over the packet network.

8. The method according to claim 1, wherein specifying the group of packet telephony terminals comprises receiving an input from a user of one of the terminals indicating a time at which the telephone conference is to begin, and wherein setting up the telephony connections comprises creating the connections automatically at the indicated time without further input from the user.

9. The method according to claim 1, wherein defining the conference topology and setting up the telephony connections comprises exchanging messages among the terminals so as to define the conference topology and set up the connections automatically, without intervention of a user.

10. The method according to claim 9, wherein exchanging the messages comprises determining that at least one of the connections connecting at least one of the terminals to the conference has been broken, and exchanging the messages during the telephone conference so as to reconnect the at least one of the terminals to the telephone conference in accordance with a backup topology.

11. The method according to claim 1, and comprising sending a multicast message over the telephony connections from a first terminal to all of the other terminals.

12. Apparatus for operation as a packet telephony terminal, comprising:
a network communication interface, for communicating with other packet telephony terminals over a packet network; and
a processor, which is arranged to receive an input specifying a group of the terminals that are to participate in a telephone conference, the group comprising the apparatus and a plurality of the other packet telephony terminals, wherein the processor is operative to define, based on the list, a conference topology in which at least two of the terminals serve as bridge nodes, comprising at least first and second bridge nodes, which are associated respectively with mutually-disjoint first and second sets of the terminals, each of the first and second sets comprising one or more of the terminals,
wherein the processor is further arranged, in conjunction with the other terminals in the group, to cause telephony connections to be set up over the packet network between the first and second bridge nodes, and between the first bridge node and each of the terminals in the first set, and between the second bridge node and each of the terminals in the second set, and to mix audio signals conveyed over the telephony connections so as to join the first and second sets of the terminals together with the first and second bridge nodes in the telephone conference.

13. The apparatus according to claim 12, wherein the conference topology comprises a tree topology, in which the bridge nodes comprise a third bridge node, which is associated with a third set of the terminals, disjoint from the first and second sets, and
wherein the telephony connections connect the first and third bridge nodes and connect the third bridge node to at least one terminal in the third set.

14. The apparatus according to claim 12, wherein the processor is arranged to define the conference topology so as to balance a computational load of mixing the audio signals between the bridge nodes.

15. The apparatus according to claim 12, wherein the processor is arranged to assign the terminals to the first and second sets responsively to a proximity between each of the bridge nodes and each of the terminals.

16. The apparatus according to claim 12, wherein the telephony connections comprise at least a first connection between the first bridge node and a first terminal in accordance with a first telephony protocol, and at least a second connection between the first bridge node and a second terminal in accordance with a second telephony protocol, different from the first telephony protocol, and
wherein the processor is arranged to mix the audio signals so as to exchange the audio signals at the first bridge node between at least the first and second connections.

17. The apparatus according to claim 12, and comprising a public switched telephone network (PSTN) interface, wherein the processor is arrange to place a call over the PSTN to an analog telephone, and to mix the audio signals so as to join the analog telephone in the telephone conference.

18. The apparatus according to claim 12, and comprising a user interface, wherein the processor is arranged to receive a list of participants specified by a user via the user interface, and to determine the terminals that are to be used respectively by the participants in the telephone conference by sending and receiving messages over the packet network.

19. The apparatus according to claim 12, wherein the processor is arranged to receive a further input from a user indicating a time at which the telephone conference is to begin, and to create the connections automatically at the indicated time without further input from the user.

20. The apparatus according to claim 12, wherein the processor is arranged to exchange messages with the other packet telephony terminals over the packet network so as to define the conference topology and set up the connections automatically, without intervention of a user.

21. The apparatus according to claim 20, wherein the processor is arranged, by exchanging the messages during the telephone conference, to determine that at least one of the connections connecting at least one of the terminals to the conference has been broken, and to reconnect the at least one of the terminals to the telephone conference in accordance with a backup topology.

22. The apparatus according to claim 12, wherein the processor is arranged to send a multicast message over the telephony connections to all of the plurality of the other terminals.

23. A system for communication, comprising a plurality of packet telephony terminals, which are interconnected via a packet network, wherein at least one of the terminals is arranged to receive an input specifying a group of the terminals that are to participate in a telephone conference, and to define, based on the list, a conference topology in which at least two of the terminals serve as bridge nodes, comprising at least first and second bridge nodes., which are associated respectively with mutually-disjoint first and second sets of the terminals, each of the first and second sets comprising one or more of the terminals,
wherein the terminals are arranged to set up telephony connections over the packet network between the first and second bridge nodes, and between the first bridge node and each of the terminals in the first set, and between the second bridge node and each of the terminals in the second set, and to mix at each of the bridge nodes audio signals conveyed over the telephony connections so as to join the first and second sets of the terminals together with the first and second bridge nodes in the telephone conference.

24. A computer software product for use on a computer that is configured to operate as packet telephony terminal in communication with other packet telephony terminals over a packet network, the product comprising a computer-readable medium in which program instructions are stored, which instructions, when read by the computer, cause the computer to receive an input specifying a group of the terminals that are to participate in a telephone conference, the group comprising the packet telephony terminal and a plurality of the other packet telephony terminals, wherein the instructions cause the computer to define, based on the list, a conference topology in which at least two of the terminals serve as bridge nodes, comprising at least first and second bridge nodes, which are associated respectively with mutually-disjoint first and second sets of the terminals, each of the first and second sets comprising one or more of the terminals,
wherein the instructions further cause the computer to operate in conjunction with the other terminals in the group so as to cause telephony connections to be set up over the packet network between the first and second bridge nodes, and between the first bridge node and each of the terminals in the first set, and between the second bridge node and each of the terminals in the second set, and cause the computer to mix audio signals conveyed over the telephony connections so as to join the first and second sets of the terminals together with the first and second bridge nodes in the telephone conference.
